(19) United States
(12) Patent Application Publication
(10) Pub. No.: US 2024/0366346 A1
(43) Pub. Date: Nov. 7, 2024

(54) SYSTEM AND METHOD FOR AUTO-DISTRIBUTION OF IMPLANT FIXTURES FOR COMPUTER-ASSISTED IMPLANT SURGERY

(71) Applicant: New York University, NEW YORK, NY (US)

(72) Inventor: Young Kwang KIM, Brooklyn, NY (US)

(21) Appl. No.: 18/653,295

(22) Filed: May 2, 2024

Related U.S. Application Data
(60) Provisional application No. 63/585,405, filed on Sep. 26, 2023.
(60) Provisional application No. 63/500,132, filed on May 4, 2023.

(51) Int. Cl. A61C 13/00; G06F 30/27

(52) U.S. Cl. CPC A61C 13/0004; G06F 30/27

(57) ABSTRACT

A method for auto-distribution of dental fixtures includes importing, via a processor, data corresponding to a computer-guided dental surgery to be performed, and analyzing, via the processor, the imported data to identify an optimal placement site for one or more implants of a dental fixture, the optimal placement site based on anatomical guideline parameters and biomechanical guideline parameters, the biomechanical guideline parameters including determination of a prosthesis-implant arch area ratio

### PRIORITY CLAIM

The present application claims priority to U.S. Provisional Patent Application Ser. No. 63/500,132 entitled “System and Method for Determining a Prosthesis-Implant Arch Area Ratio and a Prosthesis Incorporating the Same” filed on May 4, 2023 and U.S. Provisional Patent Application Ser. No. 63/585,405 entitled “System and Method for Auto-Distribution of Implant Fixtures (ADIF) for Computer-Guided Implant Surgery” filed Sep. 26, 2023, the entire disclosures of which are incorporated herein by reference.

### FIELD

The present disclosure relates to a system and a method for determining implant placement in a computer-assisted dental implant surgery.

### BACKGROUND

Tooth loss has become increasingly prevalent over the years. In the United States alone, over 36 million Americans are entirely edentulous and approximately 120 million individuals grapple with the absence of at least one tooth. These figures are poised to rise over the next two decades. The trajectory of this oral health crisis indicates that the population of partially edentulous patients is on course to surpass over 200 million within the next 15 years, affecting a majority of American adults.

While there have been recent technical advances in computer-guided implant placement (e.g., static, dynamic, robotic, and augmented reality applications) to maximize efficiency and comfort in the dental implant surgery arena, there has also been a substantial increase in diverse cases requiring a profound comprehension of engineering principles. Thus, pre-planning procedures for implant fixtures using currently existing software systems (e.g., including determining an optimal position of one or more dental implants), remain a necessary and often time-consuming aspect of dental implant surgery, which may lead to preparatory fatigue and cognitive burden among technicians and clinicians.

### SUMMARY

The present disclosure relates to a method for auto-distribution of dental fixtures. The method comprises importing, via a processor, data corresponding to a computer-guided dental surgery to be performed, and analyzing, via the processor, the imported data to identify an optimal placement site for one or more implants of a dental fixture, the optimal placement site based on anatomical guideline parameters and biomechanical guideline parameters, the biomechanical guideline parameters including determination of a prosthesis-implant arch area ratio.

The present disclosure also relates to a computer-implemented method of training a deep learning network with previously executed computer-guided dental surgery cases to provide an auto-distribution of fixtures for the pre-planning of a dental fixture to be implanted. The computer-implemented method of training the deep learning neural network comprises collecting training data including a plurality of previously executed computer-guided dental surgeries in which a size and placement site for one or more implants of dental fixtures has been determined based on anatomical guideline parameters and biomechanical guideline parameters. The biomechanical guideline parameters include the determination of a prosthesis-implant arch area. The computer-implemented method also includes training the deep-learning neural network with the training data to propose an optimal placement site for an implant of the dental fixture to be implanted.

The present disclosure also relates to a non-transitory computer-readable storage medium including a set of instructions executable by a processor. The set of instructions, when executed by the processor, causes the processor to perform operations, comprising importing, via a processor, data corresponding to a computer-guided dental surgery to be performed, and analyzing, via the processor, the imported data to identify an optimal placement site for one or more implants of a dental fixture, the optimal placement site based on anatomical guideline parameters and biomechanical guideline parameters, the biomechanical guideline parameters including determination of a prosthesis-implant arch area ratio.

### BRIEF DESCRIPTION OF THE FIGURES

FIG. 1 shows a schematic diagram of a system according to an exemplary embodiment of the present disclosure.

FIG. 2 shows a side view of an implant illustrating an anatomical guideline parameter in which a minimum required distance between the implant an adjacent tooth and/or an adjacent implant.

FIG. 3 shows a side view of an implant illustrating an anatomical guideline parameter in which a portion of the implant is implanted at bone level.

FIG. 4 shows a side view of an implant illustrating an anatomical guideline parameter in which the implant is inserted at a desired position and axis relative to bone.

FIGS. 5(a) and 5(b) show a schematic drawing of a conventional A-P spread concept with 1:1.5 ratio [FIG. 5(a)] vs. the mathematical principle of “Heron's formula” [FIG. 5(b)].

FIG. 6(a) shows a schematic diagram of platform arch area (i.e., Plat-AA) and its derivation and FIG. 6(b) shows variations of Plat-AAs on different number of implant fixtures.

FIG. 7(a) shows a schematic diagram of prosthesis arch area (i.e., Pros-AA) and its derivation and FIG. 7(b) shows variations of Pros-AAs on different number of implant fixtures & various prosthetic morphologies.

FIG. 8 graphs of Prosthesis-Implant Arch Ratios (PIAAR) of different arch width ratio groups.

FIG. 9 shows a schematic diagram of a computing device according to an exemplary embodiment of the present disclosure.

FIG. 10 shows a schematic diagram of a buccal prosthetic arch area (PROS-AA-B) for a single implant unit.

FIG. 11 shows a schematic diagram of PROS and PLAT of PIAAR for the single implant unit of FIG. 10.

FIG. 12 shows a flow diagram of a method for auto-distribution of implant fixtures according to an exemplary embodiment of the present disclosure.

FIG. 13 shows a flow diagram of a method for training a deep-learning neural network for auto-distribution of implant fixtures.

### DETAILED DESCRIPTION

The present disclosure may be understood with reference to the following description and the appended drawings. The present disclosure relates to a system and method for computer-guided surgical dental implant placement. Exemplary embodiments of the present disclosure describe a system and method via which an optimal placement of a dental implant is determined based on anatomical and/or biomechanical guideline parameters. Anatomical guideline parameters may include, for example, required minimum distances along with dimensional angulations between implants and anatomical sites (e.g., teeth, subsinasal spaces, bony concavities/undercuts, and proximity vessels and nerves) and/or positioning of implants relative to anatomical sites using bioengineering principles and matrices.

Biomechanical guideline parameters may include a prosthesis-implant arch area ratio (PIAAR), which may then be used, as inaugural dimensional/engineering parameter ranging matrices, to provide an auto-distribution of implant fixtures (ADIF) during a pre-planning stage of a computer-guided dental implant surgery. As an inaugural system, the PIARR is a calculation of the arch area from both implants and prosthesis on a full-arch implant-supported prosthesis based on the mathematical principle of Heron's formula, which calculates the unknown triangular area with known values of three sides without any angular information. Compared to conventional methods for determining implant placement for a full-arch implant supported prosthesis based on an anterior-posterior (A-P) spread, the PIAAR provides a consistent biomechanical guideline parameter that accurately calculates desired implant placement in terms of dimensional positioning for ideal access holes on the prosthetic components. Although the exemplary embodiments show and describe a full-arch implant supported prosthesis, it will be understood by those of skill in the art that the present disclosure may be similarly applied to a partial-arch implant-supported prosthesis as well as single unit implants including, for example, an implantable stem and a crown.

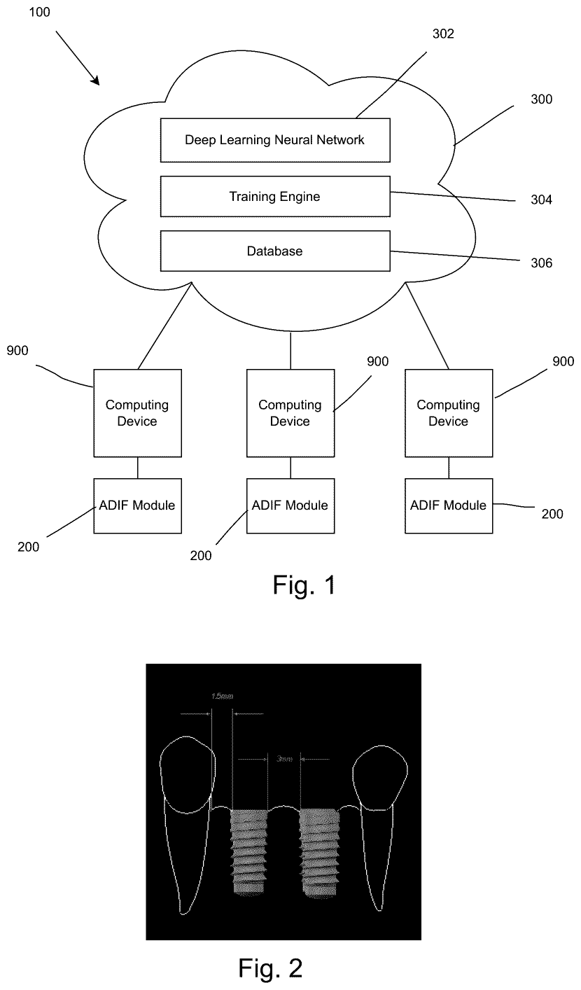

As shown in FIG. 1, a system 100 according to an exemplary embodiment of the present disclosure comprises a plurality of computing devices 900, each of which may be utilized for pre-planning of a computer-guided surgery for individual patients. Pre-planning may include, for example, execution of an auto-distribution of implant fixtures (ADIF) which indicates the automation and distribution of trajectory implant fixtures as a proposed optimal placement site for one or more implants to be implanted in alveolar crests of a patient upon importation of data files (e.g., DICOM, CBCT, and surface STL). In an exemplary embodiment, each of the plurality of computing devices 900 is configured to provide the ADIF (auto-distribution of implant fixtures) by analyzing images and/or other data corresponding to the oral and maxillofacial morphologies of a patient requiring a dental fixture based on anatomical and/or biomechanical guideline parameters.

In an exemplary embodiment, the ADIF may be implemented via an ADIF module 200 connected to and/or in communication with the plurality of computing devices 900 so that each of the computing devices 900 is capable of analyzing patient images/data according to the ADIF module 200. According to an exemplary embodiment, the system 100 further comprises a cloud server 300 connected to and/or in communication with each of the plurality of computing devices 900 so that, as pre-planning of patient cases is completed and the associated computer-guided surgeries are executed, these cases are stored to a database 306. A deep-learning neural network 302 stored on the cloud server 300 is trained via a training engine 304 using the cases stored in the database 306 so that the accuracy of the determination of the ADIF is improved over time.

In the realm of prosthetically driven implant surgery, there already exists a consensus level of ideal positional outlines and proximal distance rules of implant fixtures around critical anatomical sites. In an exemplary embodiment, anatomical guideline parameters include a known or accepted relative positioning between implants and/or anatomical sites such as, for example, teeth, subsinasal spaces, bony concavities/undercuts, and proximity vessels and nerves. Relative positioning may include, for example, required minimum distances between implants and anatomical sites, dimensional angulations between implants and anatomical sites and/or positioning of implants relative to anatomical sites based on bioengineering principles and matrices.

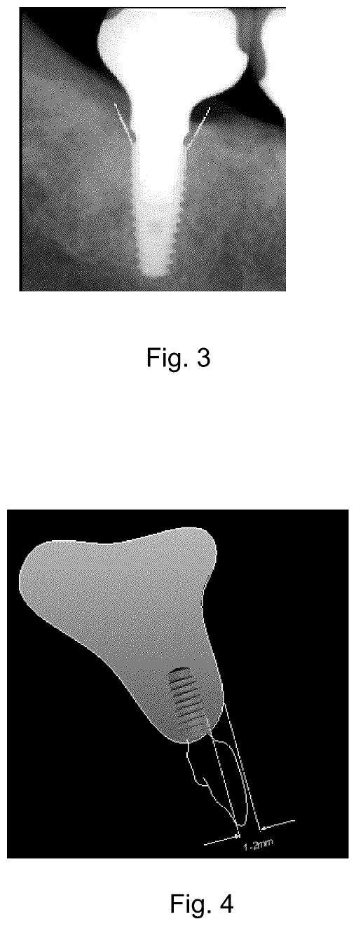

For example, as shown in FIG. 2, a minimal distance of approximately 1.5 mm from an implant shoulder to an adjacent tooth at bone level (mesial and distal) is required and a minimal distance of approximately 3.0 mm between two adjacent implant shoulder (mesiodistal) is required. As shown in FIG. 3, the implant shoulder should be sinked around 1.0-1.5 mm sub-crestally, an outer rim of the chamfer at bone level. As shown in FIG. 4, the layer of bone surrounding the bone should be at least 1 mm thick. An orofacial implant position and axis should be selected so that the screw channel of the screw retaining restoration is ideally located behind the incisal edge (anterior position) or at the center (posterior position). Although FIGS. 2-4 describe specific distances and/or positions between implants and/or anatomical sites, it will be understood by those of skill in the art that there may be a range of acceptable distances and/or positions between implants/anatomical sites.

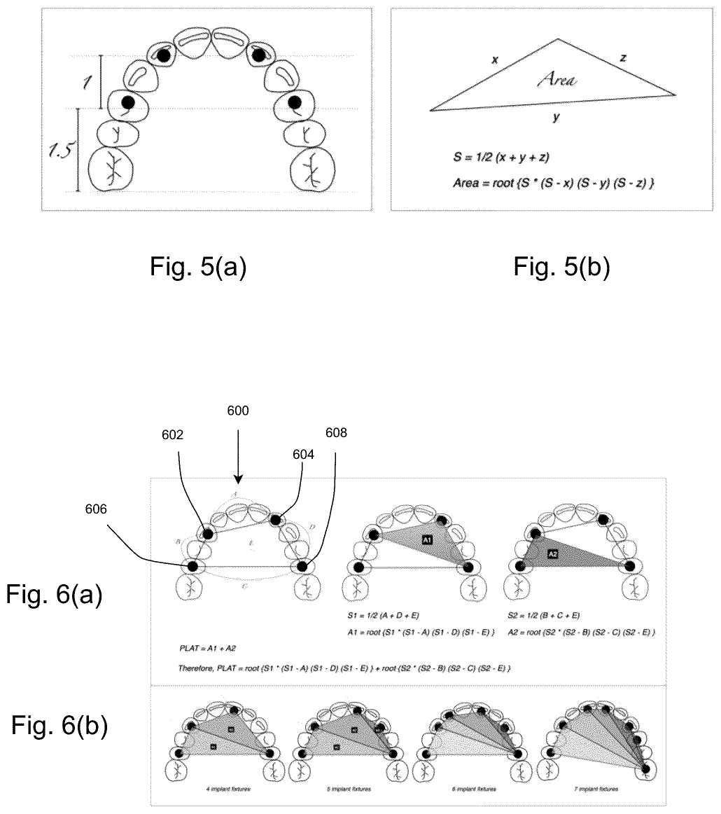

With respect to biomechanical guideline parameters, until now, the A-P spread, as shown in FIG. 5(a), has been the primary means to correlate biomechanical relevance in the distal cantilever of the prosthesis on an implant-supported fixed full-arch prosthesis. The A-P spread is the vertical distance between a linear line connecting the most terminal aspects of implants to the center of the most anteriorly distant implant (FIG. 5(a)). In the realm of the full-arch implant-supported prosthesis, many scholars have investigated A-P spread and distal cantilever to correlate in biomechanical engineering and clinical implications. Several empirical approaches to providing clinical guidelines have been attempted, yet inconsistency of implant platform distributions and prosthetic morphologies raises a significant uncertainty of its predictability, along with a wide array of other heterogenetic potentials such as 1) different widths of various arch sizes; 2) unequal distal prosthetic cantilever lengths; 3) uneven distal implant platform locations; 4) buccally flared prosthesis design.

Along with the modern trend of minimally invasive surgery, various concepts in full-mouth implant-supported rehabilitation, such as the all-on-four concept or zygomatic implants, have been successfully advanced. Often times after these surgical routes, while compensating such a narrow arch size for better esthetic and reconstructive outcome, prosthesis morphology tends to become more buccally flared out; other than addressing the hygienic issue of food impaction on the buccal prosthetic undercuts, there is no clear clinical guideline of how much buccal contouring is ideal in terms of structural integrity of biomechanical engineering. Clearly, biomechanical principles seem to be still insufficient, primarily due to a lack of precise and accurate categorization in experimental groups. For edentulous maxillary implant-supported fixed rehabilitation, a more constructive categorization of orofacial anatomy in reference to the esthetics and reconstructive prosthodontics is introduced with buccal contouring with pink gingiva prosthesis, yet there is no available study exists to investigate any potential consequence of long-span anterior prosthetic cantilevers in terms of biomechanics and prosthetic complications due to the absence of categorization.

As architectural engineering emphasizes the empirical relevance of the area interpretation for its mechanical analysis, the PIAAR concept based on Heron's formula, as shown in FIG. 5(b), provides a clear and consistent approach in reconstructive dentistry of implant biomechanics of cantilever prosthesis and is a substantial improvement over the pre-existing A-P spread concept where only linear vertical lines have been considered in three-dimensional reality.

As described above, the PIAAR which uses the concept of Heron's formula, determines a precise area calculation from distributed implant fixture platforms, providing clear biomechanical guideline parameters. For example, as shown in FIG. 6(a), if there are four implants 602, 604, 606, 608 on a fixed complete denture 600, four lines connecting the central point of each implant platforms exist (A, B, C, and D), along with one cross-sectioning line (E), all of which result in two different triangles (A1 and A2). The summation of these two triangle areas derives Plat-AA, which is the area created by four implant fixture platforms. As shown in FIG. 6(b), explicit area calculation of Plat-AA is always possible regardless of implant fixture numbers, positions, or orientations because added cross-sectioning lines can formulate multiple triangles, followed by consistent area calculation through Heron's formula.

### Prosthesis Arch Area (Pros-AA)

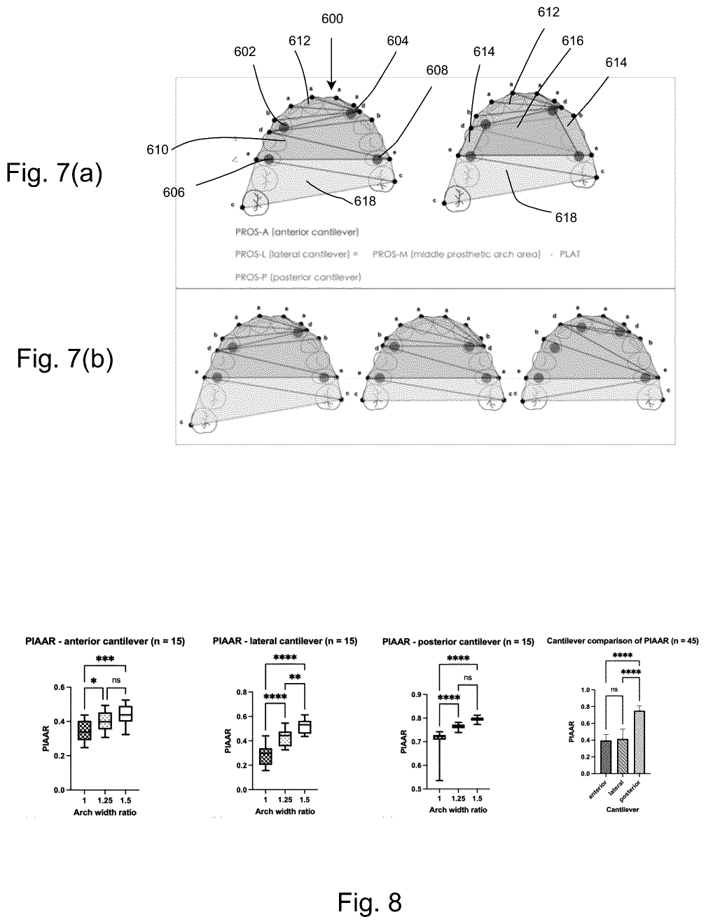

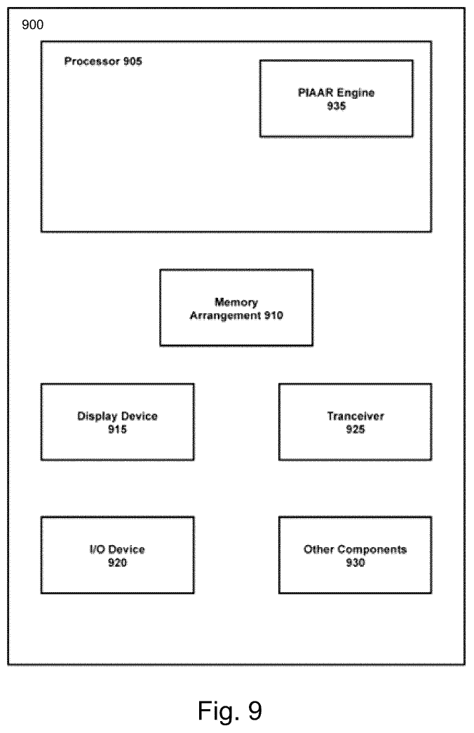

Along with four implant fixture platforms, we can draw two different lines of axis on the occlusal view-one crossing the center of the two most anterior implants 602, 604 (X-axis) and the other crossing the center of the two most distal implants 606, 608 (Z-axis). Then, as shown in FIG. 7(a), primary reference points are designated as follows:
“a” points—the most buccal point on each incisal.
“b” points—the most buccal point on each canine.
“c” points—the most buccal point on the disto-buccal cusp of the terminal tooth on each side.
“d” points—two points presenting on the prosthesis' most outer layer along the X-axis.
“e” points—two points presenting on the prosthesis' most outer layer along the Z-axis.

As shown in FIG. 7(b), different prosthetic cantilevers can be calculated as follows by connecting all these primary reference points with multiple triangles; lateral cantilever can be measured via subtracting the Pros-AA-mid (610) by Plat-AA (612).
Anterior cantilever: Pros-AA-ant (616)
Lateral cantilever: Pros-AA-lat (614)
Posterior cantilever: Pros-AA-post (618)
   With this conceptual visualization, each clinical scenario with different implant fixture orientations and various prosthetic morphologies can repeatedly draw a predictable calculation of each prosthetic cantilever's area.

### Prosthesis-Implant Arch Area Ratio (PIAAR)

Plat-AA and Pros-AA on each cantilever mentioned above can derive the following PIAARs, which can be expressed as numerical percentile values.
PIAAR-ant (anterior cantilever)=Pros-AA-ant/(Pros-AA-ant+Plat AA)
PIAAR-lat (lateral cantilever)=Pros-AA-lat/(Pros-AA-lat+Plat-AA)
PIAAR-post (posterior cantilever)=Pros-AA-post/(Pros-AA-post+Plat-AA)

The prosthesis-implant arch area ratio (PIAAR) of different arch width ratios were analyzed (n=15). Unlike the consistent conventional vertical A-P spread (1:1.5) ratio throughout all samples, analysis of variance revealed statistical significance on all PIAARs of different cantilever groups, as shown in FIG. 8. The proof-of-concept experiment clearly demonstrated that, within the same vertical ratio length of A-P spread and cantilevers of different arch morphologies, PIAAR enables a more specific categorization of cantilever status on each clinical scenario. This finding portrays a realization of possible oversimplification in the current A-P spread concept. PIAAR thus provides numerical clinical guidelines that may be useful for designing a prosthesis cantilever and/or determining precise placement sites for components of a dental fixture.

As described above, the biomechanical guideline parameters established via the PIAAR concept may, along with pre-existing anatomical guideline parameters described above (FIGS. 2-4), be utilized to provide the auto-distribution of implant fixture (ADIF), substantially reducing the time and effort required for pre-planning according to a computer-guided implant surgery. During the pre-planning stage of a dental surgery, the ADIF may propose an optimal positioning of one or more implants which, according to an exemplary embodiment, may be used to support a prosthesis (e.g., full arch, partial arch) within a patient mouth.

The ADIF may be facilitated via an ADIF module 200 which, according to an exemplary embodiment, may be provided as a plug-in to seamlessly integrate with existing dental software, utilizing the native input interface of the software to import digital imaging and communications in medicine (DICOM), cone beam computed tomography (CBCT), and standard tessellation language (STL) prosthetic blueprint files. Although the ADIF module 200 is shown and described as being configured as a plug-in configured to be connected to each of the plurality of computing devices 900 (to be integrating with existing computer-guided surgery applications supported thereby), it will be understood by those of skill in the art that the ADIF module 200 may, in another embodiment, be configured as a component of the computing device 900.

It will be understood by those of skill in the art that each of the plurality of computing devices 900 may have any of a variety of configurations. The computing device 900 may represent any electronic device and may, in an exemplary embodiment, include a processor 905, a memory arrangement 910, a display device 915, an input/output (I/O) device 920, a transceiver 925 and other components 930. The other components 930 may include, for example, an audio input device, an audio output device, a battery that provides a limited power supply, a data acquisition device, ports to electrically connect the computing device 900 to other electronic devices. For example, the computing device 900 may be coupled to a data acquisition device to plot the reference points discussed above via one or more ports.

The processor 905 may be configured to execute a plurality of engines of the computing device 900. For example, the engines may include a PIAAR engine 935, which may perform various operations related to determining the PIAAR as explained above. Although the PIAAR engine 935 is shown as being incorporated in the processor 905 of the computing device 900, it will be understood by those of skill in the art that the functionality associated with the engine may also be represented as a separate incorporated component of the computing device 900 or may be a modular component coupled to the computing device 900, e.g., a component of the ADIF module 200 that is configured to communicate with the computing device 900 to which it is connected and, in particular, the processor 905 thereof. The PIAAR engine 935 may be configured as an integrated circuit with or without firmware.

For example, the integrated circuit may include input circuitry to receive signals and processing circuitry to process the signals and other information. The engines may also be embodied as one application or separate applications. In addition, in some computing devices, the functionality described for the processor 905 is split among two or more processors such as a baseband processor and an applications processor. The exemplary embodiments may be implemented in any of these or other configurations of a computing device.

The memory arrangement 910 may be a hardware component configured to store data related to operations performed by the computing device 900. In one exemplary embodiment, the memory arrangement 910 may also include and/or be connected to the database 306 storing data associated computer-guided surgeries that have been executed using the ADIF module during the pre-planning stage. In another exemplary embodiment, the database storing data associated with executed computer-guided surgeries may be a separate storage component connected to and in communication with one or more of the computing device 900 and/or the cloud server 300.

The display device 915 may be a hardware component configured to show data to a user while the I/O device 920 may be a hardware component that enables the user to enter inputs. The display device 915 and the I/O device 920 may be separate components or integrated together such as a touchscreen. The transceiver 925 may be a hardware component configured to establish a wireless connection to a wireless network (e.g., cellular and/or WiFi). Accordingly, the transceiver 925 may operate on a variety of different frequencies or channels (e.g., set of consecutive frequencies).

As described above, the ADIF module 200 may be a component of the computing device 900 and/or a separate module connected to the computing device 900 for execution via, for example, the processor 905. The ADIF module 200 may include instructions stored on a non-transitory computer-readable storage medium, the instructions causing the computing device 900 to import data from one or more of, for example, DICOM, CBCT, and STL, and analyze the imported data to proposing optimal placement sites utilizing, for example, biomechanical guideline parameters determined via the PIAAR engine 935 along with anatomical guideline parameters. The imported data may include, for example, image scans or 3D models.

The proposed optimal placement sites may be presented to the user (e.g., clinician) via the display device 915 for approval and/or confirmation prior to implementation during execution of the computer-guided surgery. The user may approve the proposed optimal placement or adjust the proposed placement of one or more of the required implants via the I/O device 920, as desired. Upon confirming the proposed optimal placement site(s) and/or adjusting the proposed placement sites to determine final placement, the confirmed placement sites are stored to the memory arrangement 910 and/or to a separate database (e.g., database 306) in communication with one of more of the computing devices 900 and/or the cloud server 300. As described above, in an exemplary embodiment, the PIAAR engine 935 may be a component of the ADIF module 200 and/or a component of the computing device 900 that is configured to communicate with the ADIF module 200.

In an exemplary embodiment, the proposed optimal sites for the implants may be based on both an analysis of the patient data along with input from the user (e.g., clinician) such as, for example, a number of implants to be implanted, a desired prosthetic type (e.g., full arch, partial arch, or single unit). In another exemplary embodiment, however, the ADIF module 200 may identify the number of implants and/or a type of prosthetic to be utilized by analyzing the imported patient data based on, for example, anatomical guideline parameters which may be used to identify areas of tooth loss (i.e., edentulous space).

In an exemplary embodiment, the ADIF module 200 may, based on a predetermined shape of a prosthetic, identify optimal placement sites based on anatomical guidelines (e.g., required spacing between implants and/or anatomical sites such as, existing teeth and/or bone structure) along with biomechanical guidelines determined via the PIAAR (e.g., dimensional/engineering parameter range matrices). In some embodiments, the shape of the prosthetic may be based on a shape of the patient's jaw so that optimal placement sites for the implants to support the prosthetic are determined thereby using, for example, the PIARR. In other embodiments, the shape of the prosthetic may be determined based on an optimal placement of the implants which may be determined by, for example, anatomical factors.

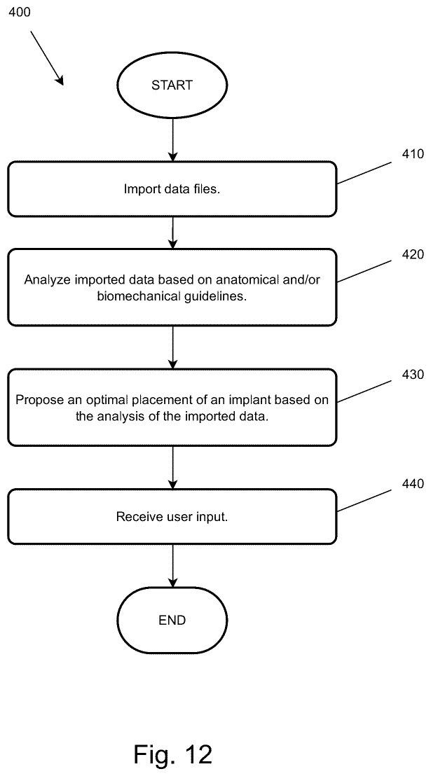

As described above and as shown in FIG. 12, according to an exemplary method 400 of the ADIF module 200, in a step 410, the processor 905 of the computing device 900 (on which the ADIF module 200 is being executed) imports data files from, for example, one of DICOM, CBCT, or STL, for a dental surgery to be performed. As described above, these data files may include, for example, image scans and/or 3D models of the patient. In a step 420, the processor 905 analyzes the imported data based on anatomical and or biomechanical guideline parameters. As discussed above, the anatomical guideline parameters may include, for example, accepted relative ranges of distance and/or accepted relative positioning between implants and anatomical sites. Biomechanical guidelines may include, for example, parameter range matrices based on PIAAR. As described below, the ADIF module 200 may be continuously updated via machine learning so that the analysis of the imported data may also be based upon learned data from previously executed computer-guided surgeries along with the anatomical guidelines and/or biomechanical guidelines.

In a step 430, the processor 905, based on the analysis of the imported data, will propose an optimal placement of one or more implant fixtures to be implanted. In an exemplary embodiment, the processor may utilize an algorithm to detect an edentulous space to identify a target site as well as dimensional position and/or angulation for the one or more implant fixtures. The proposed optimal placement, and any details associated therewith (e.g., dimension, position, and angulation of the implant relative to target site), may be displayed to the user on the display 915. In a step 440, the processor 905 will receive user input which may include one of, for example, input indicating that the user accepts and/or confirms the proposed optimal placement or input indicating adjustments to the proposed optimal placement. Any adjustments may be stored to the memory arrangement 910. Upon completion of the above-described pre-planning of the surgery, placement of the one or more implants may be accordingly implemented during the surgery.

Although the exemplary embodiments show and describe a full arch prosthetic, it will be understood by those of skill in the art that the system 100 may similarly be utilized for single unit fixtures. The analysis may include, for example, identifying a location of a missing tooth based on the anatomical guideline parameters and providing a precise location locating site of an implant based on the anatomical and/or biomechanical guideline parameters, as described in further detail below.

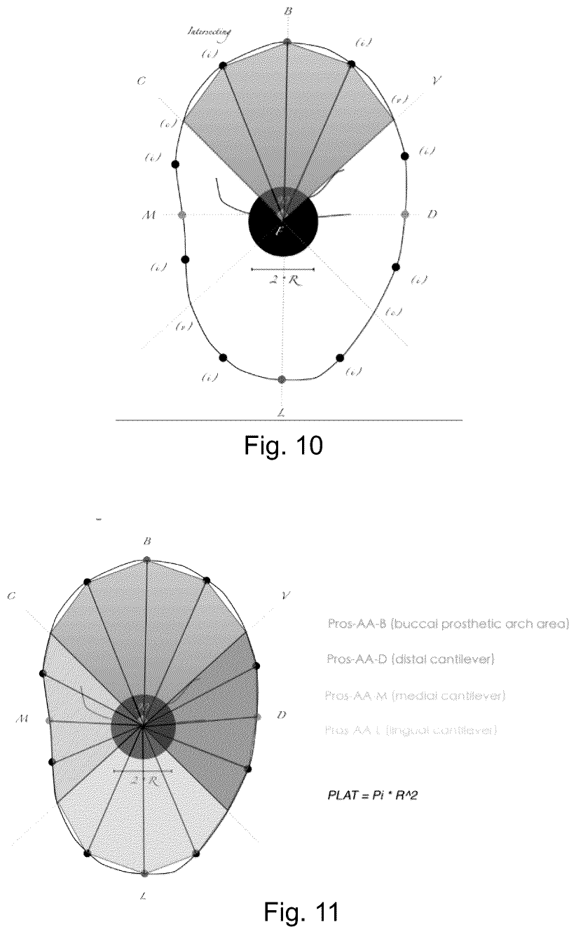

As will be understood by those of skill in the art, the PIAAR concept and the proposed optimal placement based thereon may be similarly applied to single fixation device units (e.g., singular implants). FIGS. 10-11 show single-unit PIAAR concepts according to an exemplary embodiment. In an exemplary embodiment, a single-unit PIAAR may utilize a concept of creating multiple triangles with designated points, wherein:
B point—most buccal point on occlusal view
L point—most lingual point on occlusal view
M point—most mesial point of interproximal contact
D point—most distal point of interproximal contact
B-L axis—linear line connecting B and L points
M-D axis—linear line connecting M and D points
C axis—45 degrees axis referenced from M-D axis
V axis—90 degrees axis referenced from C-axis
(c) points—points generated by C-axis
(v) points—points generated by V-axis
Intersecting (i)—equal intersecting points from major points

As described above, as real-patient cases are executed using the ADIF module 200, the data derived from executed computer-guided surgeries may be stored to the database 306. Information stored to the database 306 and used to train the deep-learning neural network 302 may include, for example, identification of edentulous spaces which may be indicative of future implant sites along, sizes of implants utilized (e.g., diameter, length), and positions thereof relative to anatomical sites. In an exemplary embodiment, the database 306 may be stored on the cloud server 300. In another exemplary embodiment, the database 306 may be stored on the memory arrangement 910 of one or more computing devices 900. In yet another exemplary embodiment, the database 306 may be a separate component or memory device on an alternate network that is accessible via the cloud server 300 and/or computing devices 900. Patient data stored in the database 306 may be encrypted to protect patient privacy so that the patient data may be stored on the cloud server and utilized for machine learning actualization in accordance with the Health Insurance Portability and Accountability Act (HIPAA).

The database 306 may be used to train the deep-learning neural network 302 that is stored on, for example, the cloud server 300. The deep-learning neural network 302 may be trained via the training engine 304, which includes instructions for training the deep-learning neural network 302. The deep-learning neural network 302 may be continuously trained as more dental surgeries are executed based on pre-planning facilitated via the ADIF module 200. The ADIF module 200 may be configured to determine subsequent proposed optimal placement sites for one or more implants of computer-guided surgeries to be performed based on the trained neural network 202, thereby improving an accuracy of optimal placement site proposals over time. In an exemplary embodiment, the optimal placement sites may include, for example, dimensional coordination of the implant such as, for example, a diameter/length of implant fixture, horizontal/vertical positions, and angulations.

The training engine 304 may include instructions for training of the deep-learning neural network 302. In an exemplary embodiment, the instructions may be executed via a processor associated with the cloud server 300. In another exemplary embodiment, the instructions of the training engine 304 may be executed via one or more of the processors 905 of any computing device 900 connected to and/or in communication with the cloud server 300. Although the deep-learning neural network 302 and the training engine 304 are shown and described as being stored to the cloud server 300, it should be noted that the functionalities described with respect to the deep-learning neural network 302 may also be represented as a separately incorporated component of the system 100, an alternate modular component connected to the computing devices 900, or as functionalities achievable via more than one processor. It will be understood by those of skill in the art that although the system 100 shows and describes a single deep-learning neural network 302, the system 100 may include a plurality of deep-learning neural networks 302, each learning model trained with training data corresponding to a different, for example, types of image data (e.g., image modality), types of dental fixtures (e.g., single unit, full arch prosthesis, partial arch prosthesis), etc.

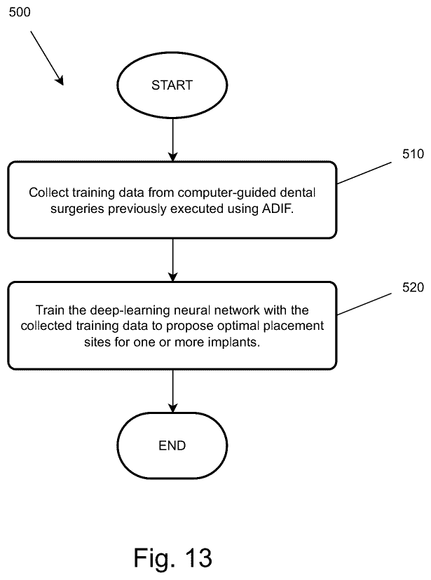

FIG. 13 shows a method 500 for training the deep-learning neural network 302 to provide ADIF for pre-planning of dental surgeries to be performed, as described above. In a step 510, the method 400 includes collecting training data. As described above, the training data may include a plurality of previously executed computer-guided dental surgeries in which a size and/or placement site for one or more implants of dental fixtures has been determined based on anatomical guideline parameters and/or biomechanical guideline parameters. In an exemplary embodiment, data associated with these previously executed computer-guided surgeries may be collected and stored to the database 306 on the cloud server 300. In a step 520, the training engine trains the deep-learning neural network 302 with the training data to propose an optimal placement site for an implant of the dental fixture to be implanted. It will be understood by those of skill in the art that although the exemplary embodiments describe the proposal of an optimal placement site, the proposal may include additional information such as for example, a proposed size of the implant and/or an orientation of the implant. It will also be understood by those of skill in the art that the deep-learning neural network 302 may be continuously trained as additional training data is collected so that the accuracy of the ADIF module 200 may continue to improve over time. As noted above, the method 500 may be implemented for more than one deep-learning network 302, each network 302 associated with, for example, a different image modality or a different type of dental fixture to be implanted. Where there is more than one deep-learning neural network 302, in the step 510, the method 500 will collect training data associated therewith—e.g., by image modality or by type of dental fixture.

Those skilled in the art will understand that the exemplary embodiments described herein may be implemented in any number of manners, including as a separate software module, as a combination of hardware and software, etc. For example, the exemplary methods may be embodiment in one or more programs stored in a non-transitory storage medium and containing lines of code that, when compiled, may be executed by at least one of the plurality of processor cores or a separate processor. In some embodiments, a system comprising a plurality of processor cores and a set of instructions executing on the plurality of processor cores may be provided. The set of instructions may be operable to perform the exemplary methods discussed above. The at least one of the plurality of processor cores or a separate processor may be incorporated in or may communicate with any suitable electronic device, for example, a mobile computing device, a smart phone, a computing tablet, a computing device, etc.

For example, the exemplary methods may be embodied in an exemplary system comprising a processing arrangement. For example, an exemplary method described herein may be performed entirely or in part by the processing arrangement. Such processing/computing arrangement may be, e.g., entirely or a part of, or include, but not limited to, a computer/processor that can include, e.g., one or more microprocessors, and use instructions stored on a computer-accessible medium (e.g., RAM, ROM, hard drive, or other storage device). A computer-accessible medium (e.g., as described herein, a storage device such as a hard disk, floppy disk, memory stick, CD-ROM, RAM, ROM, etc., or a collection thereof) may also be provided (e.g., in communication with the processing arrangement) in the system. The computer-accessible medium may be a non-transitory computer-accessible medium. The computer-accessible medium can contain executable instructions thereon. In addition, or alternatively, a storage arrangement can be provided separately from the computer-accessible medium, which can provide the instructions to the processing arrangement so as to configure the processing arrangement to execute certain exemplary procedures, processes and methods.

The disclosure described and claimed herein is not to be limited in scope by the specific embodiments herein disclosed since these embodiments are intended as illustrations of several aspects of this disclosure. Any equivalent embodiments are intended to be within the scope of this disclosure. Indeed, various modifications of the disclosure in addition to those shown and described herein will become apparent to those skilled in the art from the foregoing description. Such modifications are also intended to fall within the scope of the appended claims. All publications cited herein are incorporated by reference in their entirety.

What is claimed is:

1. A method for auto-distribution of dental fixtures, comprising:
importing, via a processor, data corresponding to a computer-guided dental surgery to be performed; and
analyzing, via the processor, the imported data to identify an optimal placement site for one or more implants of a dental fixture, the optimal placement site based on anatomical guideline parameters and biomechanical guideline parameters, the biomechanical guideline parameters including determination of a prosthesis-implant arch area ratio.

2. The method of claim 1, wherein, when the dental fixture is a full-arch prosthetic supported via a plurality of implants, the prosthesis-implant arch area ratio is defined via: (i) a first ratio of an anterior cantilever area to a sum of the anterior cantilever area and a platform arch area, (ii) a second ratio of a lateral cantilever area to a sum of the lateral cantilever area and the platform arch area, and (iii) a third ratio of a posterior cantilever area to a sum of the posterior cantilever area and the platform arch area.

3. The method of claim 2, wherein a first axis extends through centers of two most anterior implants of the plurality of implants separates the anterior cantilever area and the lateral cantilever area, and wherein a second axis extending though centers of two most distal implants of the plurality of implants separates the lateral cantilever area and the posterior cantilever area.

4. The method of claim 3, wherein a total area of the anterior, lateral, and posterior cantilever areas is further defined by a plurality of reference points comprising:
a first plurality of reference points, each of which is disposed at a most buccal point on each incisal tooth;
a second plurality of reference points, each of which is disposed at a most buccal point on each canine tooth;
a first pair of reference points, each of which is disposed at a most buccal point on a distal-buccal cusp of each terminal tooth;
a second pair of reference points, each of which is disposed at an outermost intersection point of a prosthesis with the first axis; and
a third pair of reference points, each of which is disposed at an outermost intersection point of a prosthesis with the second axis.

5. The method of claim 2, wherein the lateral cantilever area is the difference between a lateral prosthesis arch area and the platform arch area.

6. The method of claim 1, wherein, when the dental fixture is a single unit the prosthesis-implant arch area ratio is defined via: (i) a first ratio of a buccal prosthetic arch area to a sum of the buccal prosthetic arch area and a platform arch area, (ii) a second ratio of a distal cantilever area to a of the distal cantilever area and the platform arch area, (iii) a third ratio of a medial cantilever area to a sum of the medial cantilever area and the platform arch area; and (iv) a fourth ratio of a lingual cantilever area to a sum of the lingual cantilever area and the platform arch area.

7. The method of claim 1, wherein the anatomical guideline parameters include accepted relative ranges of distance between implants and anatomical sites.

8. The method of claim 1, wherein analyzing the imported data includes identifying a location of a missing tooth based on the anatomical guideline parameters.

9. The method of claim 1, further comprising identifying a number of the implants to be implanted for a dental fixture.

10. The method of claim 1, further comprising outputting a proposed optimal placement site for the one or more implants of the dental fixture.

11. The method of claim 10, further comprising receiving an input indicative of user adjustments to the proposed optimal placement site for the one or more implants.

12. A computer-implemented method of training a deep-learning neural network with previously executed computer-guided dental surgery cases to provide an auto-distribution of fixtures for pre-planning of a dental fixture to be implanted, comprising:
collecting training data including a plurality of previously executed computer-guided dental surgeries in which a size and placement site for one or more implants of dental fixtures has been determined based on anatomical guideline parameters and biomechanical guideline parameters, the biomechanical guideline parameters including determination of a prosthesis-implant arch area ratio; and
training the deep-learning neural network with the training data to propose an optimal placement site for an implant of the dental fixture to be implanted.

13. The method of claim 12, wherein the dental fixtures include one of full-arch prosthetics supported via a plurality of implants, partial-arch prosthetics supported via one or more implants, and single unit fixtures.

14. The method of claim 13, wherein, when the dental fixture is a full-arch prosthetic supported via a plurality of implants, the prosthesis-implant arch area ratio includes: (i) a first ratio of an anterior cantilever area to a sum of the anterior cantilever area and a platform arch area, (ii) a second ratio of a lateral cantilever area to a sum of the lateral cantilever area and the platform arch area, and (iii) a third ratio of a posterior cantilever area to a sum of the posterior cantilever area and the platform arch area.

15. The method of claim 14, wherein a first axis extends through centers of two most anterior implants of the plurality of implants separates the anterior cantilever area and the lateral cantilever area, and wherein a second axis extending though centers of two most distal implants of the plurality of implants separates the lateral cantilever area and the posterior cantilever area.

16. The method of claim 15, wherein a total area of the anterior, lateral, and posterior cantilever areas is further defined by a plurality of reference points comprising:
a first plurality of reference points, each of which is disposed at a most buccal point on each incisal tooth;
a second plurality of reference points, each of which is disposed at a most buccal point on each canine tooth;
a first pair of reference points, each of which is disposed at a most buccal point on a distal-buccal cusp of each terminal tooth;
a second pair of reference points, each of which is disposed at an outermost intersection point of a prosthesis with the first axis; and
a third pair of reference points, each of which is disposed at an outermost intersection point of a prosthesis with the second axis.

17. The method of claim 14, wherein the lateral cantilever area is the difference between a lateral prosthesis arch area and the platform arch area.

18. The method of claim 13, wherein, when the dental fixture is a single unit, the prosthesis-implant arch area ratio includes: (i) a first ratio of a buccal prosthetic arch area to a sum of the buccal prosthetic arch area and a platform arch area, (ii) a second ratio of a distal cantilever area to a of the distal cantilever area and the platform arch area, (iii) a third ratio of a medial cantilever area to a sum of the medial cantilever area and the platform arch area; and (iv) a fourth ratio of a lingual cantilever area to a sum of the lingual cantilever area and the platform arch area.

19. The method of claim 13, wherein the anatomical guideline parameters include accepted relative ranges of distance between implants and anatomical sites.

20. The method of claim 13, further comprising:
initiating a pre-planning of a computer-guided dental surgery including implantation of the dental fixture; and
applying the deep-learning neural network for the pre-planning of the computer-guided dental surgery to generate a proposed optimal placement of one or more implants of the dental fixture.

21. A non-transitory computer-readable storage medium including a set of instructions executable by a processor, the set of instructions, when executed by the processor, causing the processor to perform operations, comprising:
importing, via the processor, data corresponding to a computer-guided dental surgery to be performed; and
analyzing, via the processor, the imported data to identify an optimal placement site for one or more implants of a dental fixture, the optimal placement site based on anatomical guideline parameters and biomechanical guideline parameters, the biomechanical guideline parameters including determination of a prosthesis-implant arch area ratio.
